(19) United States
(12) Patent Application Publication
(10) Pub. No.: US 2018/0279826 A1
(43) Pub. Date: Oct. 4, 2018

(54) WARMING DEVICE USING ELECTROMAGNETIC INDUCTION METHOD

(71) Applicant: Chang Hyun CHUNG, Seoul (KR)

(72) Inventor: Chang Hyun CHUNG, Seoul (KR)

(21) Appl. No.: 15/759,152

(22) PCT Filed: Sep. 8, 2016
(86) PCT No.: PCT/KR2016/010113

§ 371 Date: Mar. 9, 2018

(30) Foreign Application Priority Data
Sep. 9, 2015 (KR) 10-2015-0127899

(51) Int. Cl. A47J 36/24; A47J 36/06; H05B 6/10

(52) U.S. Cl. CPC A47J 36/2472; H05B 6/108; A47J 36/06

(57) ABSTRACT

The present invention relates to a warming device using an electromagnetic induction method, comprising, a main body, in the form of a support, which includes an electromagnetic induction coil for generating a magnetic field when applying an alternating current power to an upper surface thereof, and a container having a bottom surface which is formed to be seated on the upper surface of the main body, wherein the bottom surface comprises a metal body which is induction-heated by electromagnetic interaction with the generated magnetic field when the bottom surface is seated on the upper surface of the main body. The present invention provides a warming device using an electromagnetic induction method, which maintains a constant temperature of the container, thereby always enabling a user to drink coffee or tea at a desired temperature.

### CROSS-REFERENCE TO RELATED APPLICATIONS

This patent application is a national-stage application of International Patent Application No. PCT/KR2016/010113, filed on Sep. 8, 2016, which claims priority under 35 U.S.C. § 119 to Korean Patent Application No. 10-2015-0127899, filed on Sep. 9, 2015, in the Korean Intellectual Property Office, the disclosure of which is incorporated by reference herein in its entirety.

### TECHNICAL FIELD

The present invention relates to a warming device using an electromagnetic induction scheme, and more specifically, to a warming device using an electromagnetic induction scheme, which always keeps a container at a constant temperature allowing the user to enjoy coffee or tea at his desired temperature all the time.

### DISCUSSION OF RELATED ART

The present invention relates to a warming device using an electromagnetic induction scheme.

Generally, as used in homes or offices to keep containers at a constant temperature, a device is configured as a metal plate having a heater in its portion contacting the container to directly produce heat through the heater to warm, or keep warm, the container.

In existing temperature keepers, the heater producing heat is exposed to the outside, likely causing burns when contacting the user's skin or a fire upon a long-term contact to paper or other combustibles.

Further, heat generated from the heater may be lost before transferred to the container. Thus, despite high power consumption, the container may insufficiently be warmed, rendering it difficult to keep the container at a high temperature.

### SUMMARY

Conceived to address the above-described problems, the present invention aims to provide a warming device using an electromagnetic induction scheme to keep the temperature of a container constant, always allowing the user to enjoy coffee or tea at a desired temperature.

Further, another object of the present invention is to provide a warming device using an electromagnetic induction scheme which is able to keep the container at a constant temperature in a safe manner without the risk of burns or fire.

Still another object of the present invention is to provide a warming device using an electromagnetic induction scheme, which is capable of effectively maintaining the temperature of container by enabling quick heat transfer while lowering the power consumption thanks to high heat efficiency.

Yet still another object of the present invention is to provide a warming device using an electromagnetic induction scheme, which may automatically operate its temperature keeping function by simply placing a container thereon.

The foregoing or other various advantages of the present invention will further be apparent to one of ordinary skill in the art form the detailed description of preferred embodiments of the present invention.

To achieve the above objectives, according to the present invention, the present invention comprises a main body, in the form of a prop, including, in a top thereof, an electromagnetic induction coil generating a magnetic field when applied with alternating current (AC) power and a container having a bottom formed to be seated on the top of the main body and including, in the bottom of the container, a metal body inductively heated by electromagnetic interoperation by a magnetic field produced when the bottom of the container is placed on the top of the main body.

Further, an inside surface of the container is formed of a thermal-conductive metal or a thermal-conductive resin.

Further, an outside surface of the container is formed of a heat-insulative resin.

Further, the main body enables a degree of the metal body heating by including a resonance circuit controller including a resonance capacitor connected with the electromagnetic induction coil and adjusting overall impedance by the resonance capacitor to adjust the magnitude of a magnetic field produced from the electromagnetic induction coil and a temperature controller controlling an operation of the resonance circuit controller so that the magnitude of the magnetic field produced from the electromagnetic induction coil by the resonance circuit controller is adjusted to a magnitude corresponding to the temperature of the metal body heated.

Further, the main body includes a detection sensor detecting whether the container is placed on the top of the main body, and the main body further includes a power switching unit allowing the AC power to be applied to the electromagnetic induction coil only when the detection sensor detects that the container is placed on the top of the main body.

Further, a temperature sensor is further provided inside the container, and wherein a temperature of the inside of the container measured by the temperature sensor is output through a display provided on a side of the main body or an outer surface of the container.

Further, the container includes a cover opening or closing the top opened and a temperature sensor detecting a temperature of a content contained therein, wherein the cover includes an opening configured to circulate air between an inside and outside of the container and a door slid by a micromotor to open or close the opening, and wherein the container further include a controller controlling an operation of the micromotor so that the door opens the opening if a temperature detected by the temperature sensor is a preset temperature or more.

Further, a receiving part depressed from an upper side to a lower side thereof is formed in the top of the main body, wherein the electromagnetic induction coil is included inside a bottom of the receiving part, and wherein the container is formed in a corresponding shape to be received in the receiving part.

As set forth above, according to the present invention, there may be provided a warming device using an electromagnetic induction scheme to keep the temperature of a container constant, always allowing the user to enjoy coffee or tea at a desired temperature.

Further, according to the present invention, there may be provided a warming device using an electromagnetic induction scheme which is able to keep the container at a constant temperature in a safe manner without the risk of burns or fire.

Further, according to the present invention, there may be provided a warming device using an electromagnetic induction scheme, which is capable of effectively maintaining the temperature of container by enabling quick heat transfer while lowering the power consumption thanks to high heat efficiency.

Further, according to the present invention, there may be provided a warming device using an electromagnetic induction scheme, which may automatically operate its temperature keeping function by simply placing a container thereon.

### BRIEF DESCRIPTION OF THE DRAWINGS

FIG. 1 is a perspective view illustrating a warming device using an electromagnetic induction scheme according to a preferred embodiment of the present invention.

FIG. 2 is a cross-sectional view illustrating a warming device using an electromagnetic induction scheme according to a preferred embodiment of the present invention.

FIG. 3 is a block diagram illustrating a warming device using an electromagnetic induction scheme according to a preferred embodiment of the present invention.

FIG. 4 is a block diagram illustrating a method for opening and closing an opening of a cover in a warming device using an electromagnetic induction scheme according to a preferred embodiment of the present invention.

FIG. 5 is a perspective view illustrating a cover of a warming device using an electromagnetic induction scheme according to a preferred embodiment of the present invention.

FIG. 6 is a block diagram illustrating a method for detecting and displaying beverage consumption in a warming device using an electromagnetic induction scheme according to a preferred embodiment of the present invention.

FIG. 7 is a cross-sectional view illustrating a warming device using an electromagnetic induction scheme according to another preferred embodiment of the present invention.

### DETAILED DESCRIPTION OF EXEMPLARY EMBODIMENTS

Advantages and features of the present invention and methods to achieve the same will be apparent from embodiments described below taken in conjunction with the accompanying drawings.

However, the present invention is not limited to embodiments described below, but may rather be implemented in other various forms. The embodiments herein are provided merely to make the disclosure of the present invention more thorough and to fully convey the category of the present invention to one of ordinary skill in the art to which the present invention pertains. The present invention is defined only by the appended claims. The same reference denotation refers to the same element throughout the specification.

Hereinafter, embodiments of the present invention of a warming device using an electromagnetic induction scheme are described with reference to the accompanying drawings.

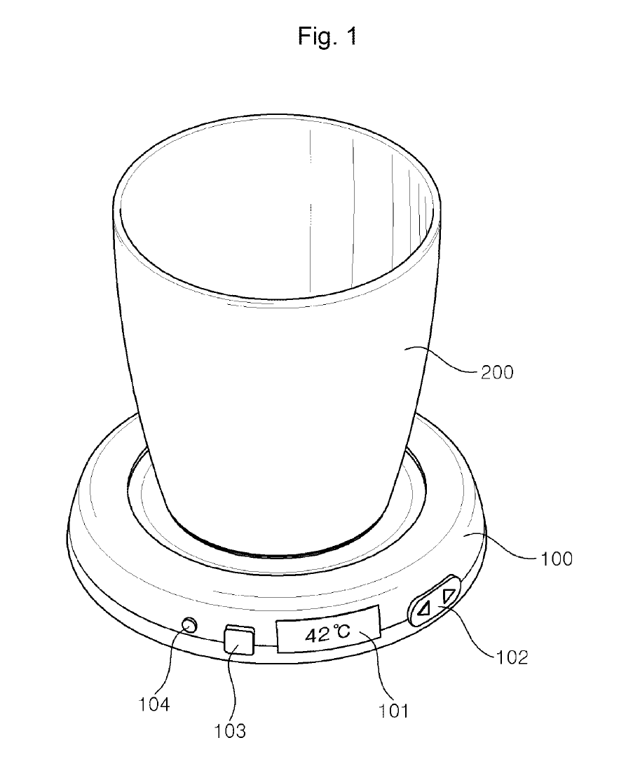

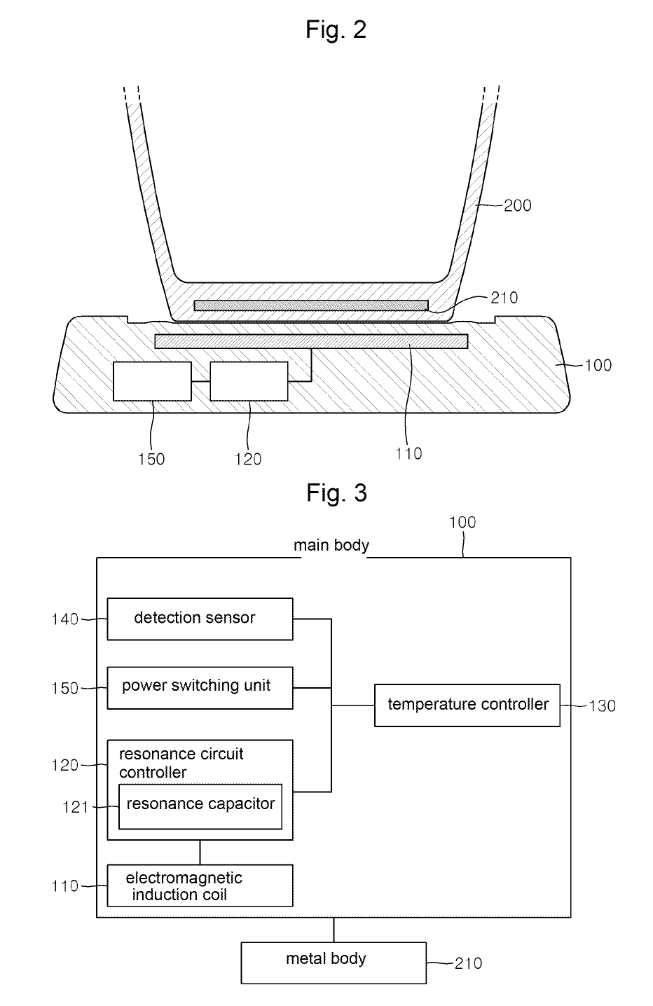

FIG. 1 is a perspective view illustrating a warming device using an electromagnetic induction scheme according to a preferred embodiment of the present invention. FIG. 2 is a cross-sectional view illustrating a warming device using an electromagnetic induction scheme according to a preferred embodiment of the present invention.

Referring to FIGS. 1 and 2, according to a preferred embodiment of the present invention, a warming device using an electromagnetic induction scheme includes a main body 100 producing a magnetic field across an electromagnetic induction coil 110 when applied alternating current (AC) power from the outside and a container 200 placed on the main body 100 to heat or keep a beverage therein at a constant temperature.

As representative examples, the container 200 may be a cup or bowl to contain water, coffee, tea, or other drinks, but is not limited in its use or shape.

Preferably, an inside surface of the container may be formed of a thermal-conductive metal, such as stainless, or a thermal-conductive resin to maintain heat produced, and an outside side of the container may be formed of a heat insulative resin to prevent heat transfer from the inside of the container to the outside.

A vacuum layer may be provided on the outside surface of the container to trap heat inside the container.

A bottom of the container 200 may be formed to be seated on the top of the main body 100, allowing the container 200 to be placed on the top of the main body 100. A metal body 210 may be provided in the bottom of the container 200, causing an electromagnetic interoperation by a magnetic field produced from the electromagnetic induction coil 110 and thereby inductively heating the metal body 210.

FIG. 3 is a block diagram illustrating a warming device using an electromagnetic induction scheme according to a preferred embodiment of the present invention.

Referring to FIG. 3, since the temperature of the beverage in the container 200 is determined depending on the temperature of the metal piece 210 inductively heated, the main body 100 may include a resonance circuit controller 120 and a temperature controller 130 to provide water, coffee, or tea at the user's desired temperature.

The resonance circuit controller 120 includes a resonance capacitor 121 connected with the electromagnetic induction coil 110, and the resonance circuit controller 120 adjusts the overall impedance by the resonance capacitor 121 to adjust the magnitude of a magnetic field produced from the electromagnetic induction coil 110. Accordingly, the temperature controller 130 may control the operation of the resonance circuit controller 120 so that the magnitude of a magnetic field produced from the electromagnetic induction coil 110 by the resonance circuit controller 120 is adjusted to a magnitude corresponding to the temperature of heat produced from the metal body 210.

The man body 100 may further include a detection sensor 140 provided as a contact sensor or weight sensor and a power switching unit 150.

The detection sensor 140 is able to detect the presence or absence of the container 200 on the top of the main body 100, and the detection sensor 140 enables the power switching unit 150 to apply AC power to the electromagnetic induction coil 110 only upon detecting the container 200 is placed on the top of the main body 100.

A temperature sensor 220 may be provided inside the container 200. The temperature of the inside of the container, which is measured by the temperature sensor 220, may be output through a display 101 provided on a side of the main body 100 or an outer surface of the container. The temperature measured may be shown as an exact number as shown in FIG. 1 or may be displayed through a red LED as the temperature is high or a blue LED as the temperature is low.

On the outer surface of the main body 100 may further be provided a temperature input unit 102, a power button 103 for supplying or cutting off the supply of AC power to the main body 100, and a power display 104 capable of displaying the state of power of the main body 100. The user's desired temperature may be entered through the temperature input unit 120 that may be provided in a button type to temporarily display a selected temperature through the display 101.

The power display 104 may generally include a blue LED and a red LED so that the blue LED may light on upon warming, and the red LED light on in a power standby state where warming stops, or vice versa.

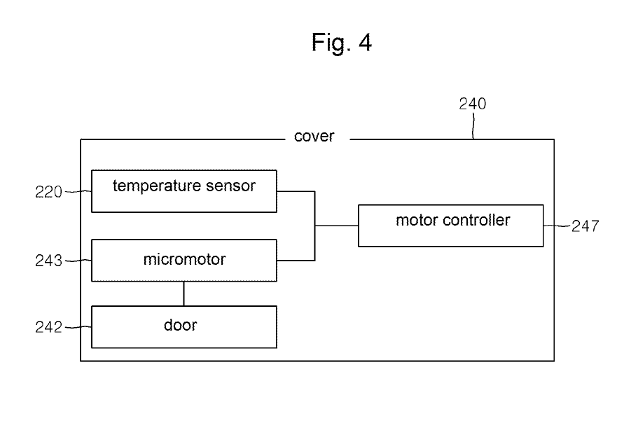

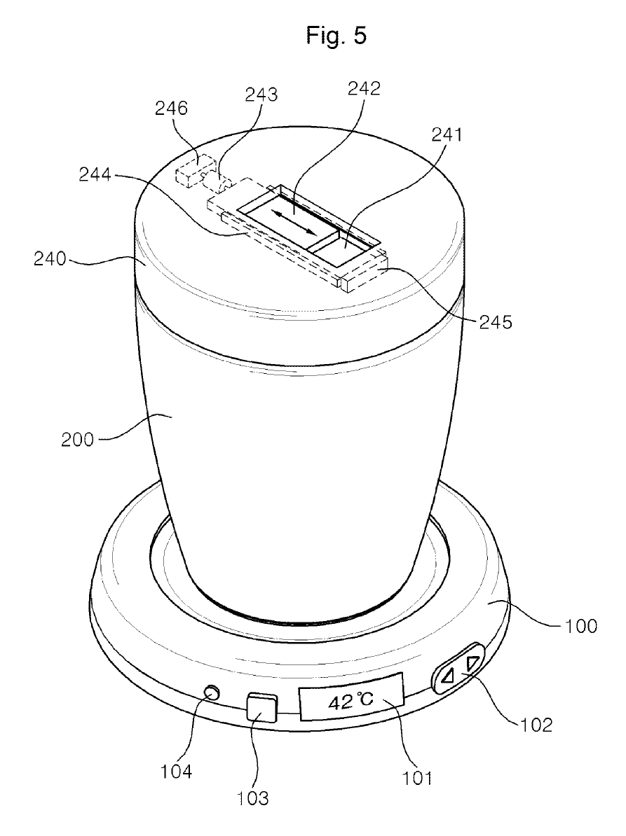

FIG. 4 is a block diagram illustrating a method for opening and closing an opening of a cover in a warming device using an electromagnetic induction scheme according to a preferred embodiment of the present invention. FIG. 5 is a perspective view illustrating a cover of a warming device using an electromagnetic induction scheme according to a preferred embodiment of the present invention.

Referring to FIGS. 4 and 5, an opening 241 may be formed in the top of the container to allow the inside of the container to communicate with the outside, and a door 242 may be provided on the top of the container to open and close the opening 241.

The opening 241 may be formed in the whole or part of the top of the container. A cover 240 may further be provided to open or close the overall top of the container, and the opening 241 may be formed in the cover 240 to vent air between inside of the container 200 and the outside.

The user may drink the beverage in the container 200 through the opening 241 with the container 200 tightly covered with the cover 240.

The door 242 may be connected with a micromotor 242. Upon sensing a preset temperature or more by the temperature sensor 220, a motor controller 247 may control the operation of the micromotor 242 to open the opening 241.

Conversely, upon reaching a preset temperature or less, the door 242 may airtightly close the opening 241 by the operation of the micromotor 242, and the micromotor 242 may be driven by a battery 246.

A guide 244 is further provided at both sides of the opening 241 to allow the door 242 to slide along the guide 244 to open or close the opening 241. A packing 245 is further provided where the door 242 contacts the cover 240 when the door 242 closes the opening 241, airtightly sealing the opening 241.

Further, according to a preferred embodiment of the present invention, in the warming device using the electromagnetic induction scheme, the amount of beverage drunken through the container 200 may automatically be counted, and there may be provided information obtained by comparing the counted amount with an amount recommended for health-care or beauty purposes.

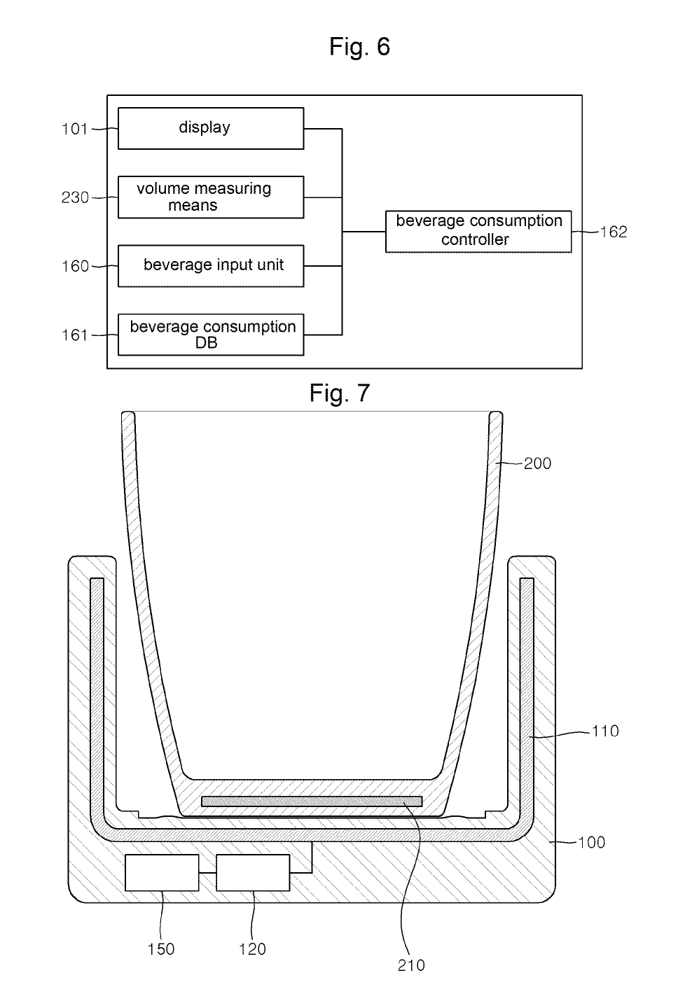

FIG. 6 is a block diagram illustrating a method for detecting and displaying beverage consumption in a warming device using an electromagnetic induction scheme according to a preferred embodiment of the present invention.

Referring to FIG. 6, to that end, the container 200 further includes a volume measuring means 230 to detect the amount of beverage contained in the container 200 and the amount of beverage consumed, and such information, along with information such as type of the beverage, and date and time the beverage was drunken, is stored through a beverage consumption controller 162 in a beverage consumption DB 161.

The user may enter, e.g., the type of beverage contained in the container 200 and the amount of beverage supposed to be consumed on each day, through a beverage input unit 160 configured on the outer surface of the main body 100 or the container 200, and the information about the type and amount of beverage consumed on the day may be extracted from the beverage consumption DB 161 and displayed through the display 101.

Further, the amount of beverage recommended for staying healthy or in beauty and the amount of beverage actually consumed by the user may be compared, and a beverage consumption achievement ratio may be displayed together.

FIG. 7 is a cross-sectional view illustrating a warming device using an electromagnetic induction scheme according to another preferred embodiment of the present invention.

Referring to FIG. 7, the main body 100 may be formed to surround the outer side of the container 200 while allowing the bottom of the container 200 to be placed thereon, leading to more stable placement of the container 200 along with a maximized effect of keeping warm.

The electromagnetic induction coil 110 of the main body 100 may be configured in the side of the main body 100 as well as in the top of the main body 100, thereby increasing the magnitude of magnetic field produced when applied with AC power. The metal body 210 in the container 200 is not limited as being provided in the bottom of the container 200 and is also provided in the side of the container 200 to achieve more active electromagnetic interaction with the electromagnetic induction coil 110, thereby allowing the metal body 210 to quickly heat up.

Further, according to a preferred embodiment of the present invention, the main body 100 of the warming device using the electromagnetic induction scheme may be integrally formed with the top of, e.g., a desk or the user's work station, so that the container 200 may be kept warm by simply placing the container 200 on the main body (100)-embedded or integrated desk or work station.

It will be appreciated by one of ordinary skill in the art that the present invention may be practiced in other specific forms without altering the technical spirit or essential features thereof. Therefore, it should be understood that the embodiments set forth herein are exemplary in all aspects and are not limiting. The scope of the present invention should be defined by the claims appended, not by the detailed description above, and all modifications or variations derived from the meaning and scope of the claims and equivalents thereof should be construed as included in the scope of the present invention.

What is claimed is:

1. A warming device using an electromagnetic induction scheme, the warming device comprising: a main body, in the form of a prop, including, in a top thereof, an electromagnetic induction coil generating a magnetic field when applied with alternating current (AC) power; and
a container having a bottom formed to be seated on the top of the main body and including, in the bottom of the container, a metal body inductively heated by electromagnetic interoperation by a magnetic field produced when the bottom of the container is placed on the top of the main body.

2. The warming device of claim 1, wherein an inside surface of the container is formed of a thermal-conductive metal or a thermal-conductive resin.

3. The warming device of claim 1, wherein an outside surface of the container is formed of a heat-insulative resin.

4. The warming device of claim 1, wherein the main body enables a degree of the metal body heating by including a resonance circuit controller including a resonance capacitor connected with the electromagnetic induction coil and adjusting overall impedance by the resonance capacitor to adjust the magnitude of a magnetic field produced from the electromagnetic induction coil and a temperature controller controlling an operation of the resonance circuit controller so that the magnitude of the magnetic field produced from the electromagnetic induction coil by the resonance circuit controller is adjusted to a magnitude corresponding to the temperature of the metal body heated.

5. The warming device of claim 1, wherein the main body includes a detection sensor detecting whether the container is placed on the top of the main body, and the main body further includes a power switching unit allowing the AC power to be applied to the electromagnetic induction coil only when the detection sensor detects that the container is placed on the top of the main body.

6. The warming device of claim 1, wherein a temperature sensor is further provided inside the container, and wherein a temperature of the inside of the container measured by the temperature sensor is output through a display provided on a side of the main body or an outer surface of the container.

7. The warming device of claim 1, wherein the container includes a cover opening or closing the top opened and a temperature sensor detecting a temperature of a content contained therein, wherein the cover includes an opening configured to circulate air between an inside and outside of the container and a door slid by a micromotor to open or close the opening, and wherein the container further include a controller controlling an operation of the micromotor so that the door opens the opening if a temperature detected by the temperature sensor is a preset temperature or more.

8. The warming device of claim 1, wherein a receiving part depressed from an upper side to a lower side thereof is formed in the top of the main body, wherein the electromagnetic induction coil is included inside a bottom of the receiving part, and wherein the container is formed in a corresponding shape to be received in the receiving part.
